(19) United States
(12) Patent Application Publication
(10) Pub. No.: US 2018/0001587 A1
(43) Pub. Date: Jan. 4, 2018

(54) SLOTTER HEAD, SLOTTER APPARATUS, AND BOX MAKING MACHINE

(71) Applicant: MITSUBISHI HEAVY INDUSTRIES PRINTING & PACKAGING MACHINERY, LTD., Mihara-shi, Hiroshima (JP)

(72) Inventors: Kunihiko YAMAMURO, Mihara-shi, Hiroshima (JP); Kazuya SUGIMOTO, Mihara-shi, Hiroshima (JP); Osamu HATANO, Mihara-shi, Hiroshima (JP)

(21) Appl. No.: 15/543,569

(22) PCT Filed: Nov. 24, 2015
(86) PCT No.: PCT/JP2015/082912

§ 371 Date: Jul. 13, 2017

(30) Foreign Application Priority Data
Jan. 14, 2015 (JP) 2015-005330

(51) Int. Cl. B31B 50/22; B31B 50/62; B31B 50/26; B31B 50/88; B26D 1/29; B31B 50/25; B31B 50/83; B26D 1/00; B31B 2110/35; B31B 2120/30

(52) U.S. Cl. CPC B31B 50/22; B31B 50/252; B31B 50/624; B31B 50/262; B31B 50/83; B31B 50/88; B26D 1/295; B31B 2110/35; B31B 2120/30; B26D 2001/0033; B26D 2001/006; B26D 2001/0093

(57) ABSTRACT

A slotter head, a slotter apparatus, and a box making machine form a joining piece with a high degree of accuracy by each being provided with: a cutter rest; a movable block mounted in an outer peripheral portion of the cutter rest; a first cutting blade that is fixed to the movable block along a shaft direction and along a direction inclined in a circumferential direction by a predetermined angle; a first support shaft that supports, on the cutter rest, the movable block rotatably around a first shaft center along the shaft direction; and a second support shaft that supports, on the cutter rest, the movable block rotatably around a second shaft center along the circumferential direction.

### RELATED APPLICATIONS

The present application is a National Phase of PCT International Application No. PCT/JP2015/082912, filed Nov. 24, 2015 which claims the benefit of priority from Japanese Patent Application No. 2015-005330, filed Jan. 14, 2015.

### FIELD

The present invention relates to: a slotter head that forms a joining piece in a corrugated board sheet in a process of making a corrugated board box; a slotter apparatus that has the slotter head; and a box making machine that has the slotter apparatus.

### BACKGROUND

A general box making machine makes a box body (corrugated board box) by processing a sheet material (for example, a corrugated board sheet), and is formed of a feeder unit, a printing unit, a slotter creaser unit, a die cut unit, a folding unit, and a counter-ejector unit. The feeder unit feeds corrugated board sheets stacked on a table to the printing unit at a constant velocity by sending out the corrugated board sheet one by one. The printing unit has a printer unit, and executes printing on the corrugated board sheet. On the printed corrugated board sheet, the slotter creaser unit forms creasings serving as fold lines, and executes formation of: slots forming flaps; and a gluing margin piece for joining. The die cut unit executes punching for hand holes in the corrugated board sheet, in which the creasings, slots, and gluing margin piece have been formed. The folding unit applies a glue on the gluing margin piece, folds the corrugated board sheet along the creasings, and performs joining of the gluing margin piece, while moving the corrugated board sheet, in which the creasing, slots, gluing margin piece, and hand holes have been formed, to thereby make a corrugated board box in a flat form. The counter-ejector unit stacks the corrugated board boxes that have been made by the corrugated board sheets being subjected to the folding and gluing, and ejects the corrugated board boxes by sorting the corrugated board boxes into a predetermined number of batches.

In a slotter creaser unit of such a box making machine, plural creasing rolls form creasings on a corrugated board sheet that has been subjected to printing, and plural slotter heads form slots forming flaps and a gluing margin piece for joining. In this case, the gluing margin piece is formed by an end portion of the corrugated board sheet being cut off by a first knife fixed to an outer peripheral portion of a slotter head, along a circumferential direction thereof, and a second knife fixed to the outer peripheral portion of the slotter head, along a width direction thereof. Since this gluing margin piece is trapezoidal, the second knife is fixed to the outer peripheral portion of the slotter head so as to be inclined in the circumferential direction, with respect to the width direction, by a predetermined angle. Therefore, when the end portion of the corrugated board sheet is cut off between the slotter head and a lower blade, a cutting portion of the second knife partially contacts and does not evenly contact an outer peripheral surface of the lower blade, and formation of the gluing margin piece is thus difficult.

Techniques for solving such a problem include, for example, a technique described in patent literature cited below. A flat portion cutting apparatus related to a rotary slotter machine described in Patent Literature 1 has a holder, to which a joint cutter has been fixed, the holder being rotatably attached to a chip slotter knife via an attachment pin and being supported by elastic rubber. Further, an apparatus for holding a cutting blade for processing corrugated boards described in Patent Literature 2 has a support tool, to which the cutting blade has been fixed, the support tool being supported by a cushion material on an attachment body.

### CITATION LIST

### Patent Literature

Patent Literature 1: Japanese Examined Utility Model (Registration) Application Publication No. S58-016843 A

Patent Literature 2: Japanese Examined Utility Model (Registration) Application Publication No. S54-018503 A

### SUMMARY

### Technical Problem

When a slotter head cuts off a part of a corrugated board sheet to form a slot or a gluing margin piece, a distance between the slotter head and a lower blade needs to be adjusted to an appropriate distance according to the type of the corrugated board sheet (thickness, material, and the like). Thus, like the flat portion cutting apparatus in Patent Literature 1, even if the joint cutter is supported rotatably in one direction, when a distance between the slotter head and the lower blade is changed, the cutting portion of the joint cutter and the outer peripheral surface of the lower blade will be positionally displaced from each other. Further, like the apparatus for holding a cutting blade for processing corrugated boards in Patent Literature 2, if the cutting blade is elastically supported, the cutting blade will be shaken in any direction, and when the pressing force of the cutting blade is increased, this cutting blade may obliquely contact the outer peripheral surface of the lower blade and it will then become difficult for the gluing margin piece to be formed with a high degree of accuracy.

The present invention solves the above described problems, and an object thereof is to provide a slotter head, a slotter apparatus, and a box making machine, which are able to form joining pieces with a high degree of accuracy.

### Solution to Problem

In order to achieve the above described object, a slotter head according to the present invention includes a cutter rest that is disk shaped, and is rotatably supported, a movable block that is mounted in an outer peripheral portion of the cutter rest, a first cutting blade that is fixed to the movable block along a rotation shaft center direction of the cutter rest and along a direction inclined in a circumferential direction by a predetermined angle, a first support shaft that supports, on the cutter rest, the movable block rotatably around a first shaft center along the rotation shaft center direction of the cutter rest, and a second support shaft that supports, on the cutter rest, the movable block rotatably around a second shaft center along a circumferential direction of the cutter rest.

Therefore, the movable block, to which the first cutting blade has been fixed along the rotation shaft center direction of the cutter rest and along the direction inclined in the circumferential direction, is rotatable, due to the first support shaft, around the first shaft center along the rotation shaft center direction of the cutter rest, and is rotatable, due to the second support shaft, around the second shaft center along the circumferential direction of the cutter rest. Therefore, as the sheet is conveyed between the first cutting blade and the outer peripheral surface of the receiving side slotter head opposite to the first cutting blade, the first cutting blade cuts the sheet while rotating in the two intersecting directions, and thus the first cutting blade is able to cut and form the joining piece with a high degree of accuracy by evenly contacting, without partially contacting, the outer peripheral surface of the receiving side slotter head. Further, even if the inter-shaft distance between a pair of slotter heads is adjusted according to the type of the sheet, since the first cutting blade is rotatable in the two intersecting directions, the first cutting blade is able to be evenly contacted with the outer peripheral surface of the receiving side slotter head.

In the slotter head according to the present invention, a biasing member that biases the movable block outward with respect to the cutter rest, and a restricting member that restricts an amount of outward rotation of the movable block by the first support shaft with respect to the cutter rest, are provided.

Therefore, the movable block is biased outward by the biasing member, and the amount of outward rotation is restricted by the restricting member, and thereby, the first cutting blade is supported at a predetermined protruded position by the restricting member. Accordingly, when the first cutting blade cuts the sheet, the first cutting blade rotates in the two intersecting directions while retracting against the biasing force of the biasing member correspondingly to the outer peripheral surface of the receiving side slotter head, and thus the joining piece is able to be cut with a high degree of accuracy.

In the slotter head according to the present invention, a link member having the second support shaft is rotatably supported on the cutter rest by the first support shaft, and the movable block is rotatably supported on the link member by the second support shaft.

Therefore, the link member is supported on the cutter rest by the first support shaft, and the movable block is supported on the link member by the second support shaft, and thereby, the first support shaft, the second support shaft, and the first cutting blade are able to be arranged closely to each other, and the whole configuration is able to be made compact.

In the slotter head according to the present invention, the biasing member is arranged between the cutter rest and the movable block, the second support shaft is fitted into a support hole of the movable block and a distal end portion of the second support shaft protrudes therefrom, and outward movement thereof is restricted by the restricting member.

Therefore, by the restricting member supporting the distal end portion of the second support shaft penetrating through the movable block; with the simple configuration, the amount of rotation of the movable block is able to be restricted easily.

In the slotter head according to the present invention, the distal end portion of the second support shaft is movably supported on a notch guide that is provided, in the outer peripheral portion of the cutter rest, and along a radial direction of the cutter rest.

Therefore, by the distal end portion of the second support shaft being supported on the notch guide, the movement of the movable block in the shaft center direction of the first support shaft is restricted, and the movable block is able to be rotated with a high degree of accuracy.

In the slotter head according to the present invention, a link member is rotatably supported on the cutter rest by the second support shaft, and the movable block is rotatably supported on the link member by the first support shaft.

Therefore, the link member is supported on the cutter rest by the second support shaft, and the movable block is supported on the link member by the first support shaft, and thereby, the configuration is able to be simplified.

In the slotter head according to the present invention, outward movement of the movable block is restricted by the biasing member being arranged between the cutter rest and the movable block; a third support shaft being fixed to the movable block, the third support shaft protruding in the circumferential direction of the cutter rest, and the third support shaft being movably fitted into and supported by an elongated hole guide provided, in the restricting member, along a radial direction of the cutter rest.

Therefore, by the third support shaft protruding from the movable block being supported by the elongated hole guide of the restricting member, the amount of rotation of the movable block is able to be restricted easily with the simple configuration, the movement of the movable block in the shaft center direction of the first support shaft is restricted, and thus the movable block is able to be rotated with a high degree of accuracy.

In the slotter head according to the present invention, the first shaft center is positioned in a direction parallel to the first cutting blade, and the second shaft center is positioned in a direction orthogonal to the first cutting blade.

Therefore, the first cutting blade rotates in its longitudinal direction and a direction orthogonal to the longitudinal direction, and thus is able to cut the sheetwith a high degree of accuracy.

In the slotter head according to the present invention, a second cutting blade along the circumferential direction of the cutter rest is fixed to the cutter rest, adjacently to the movable block in the rotation shaft center direction of the cutter rest, a recessed portion is provided in one of planar portions of the second cutting blade, and one of end portions of the first cutting blade is arranged in the recessed portion.

Therefore, by the end portion of the first cutting blade being arranged in the recessed portion of the second cutting blade, a corner portion of the joining piece is able to be cut with a high degree of accuracy.

Further, a slotter apparatus according to the present invention includes an upper rotation shaft and a lower rotation shaft that are rotatably supported, an upper slitter head and a lower slitter head that are respectively fixed to the upper rotation shaft and the lower rotation shaft, and cut off an end portion of a sheet, an upper slotter head and a lower slotter head for slotting that are respectively fixed to the upper rotation shaft and the lower rotation shaft, and execute slotting of the sheet, and an upper slotter head and a lower slotter head for joining piece formation that are respectively fixed to the upper rotation shaft and the lower rotation shaft, and form a joining piece of the sheet. The slotter head described above is used as the upper slotter head for joining piece formation.

Therefore, the upper slitter head cuts off the end portion of the sheet, the upper slotter head for slotting executes slotting of the sheet, and the second upper slotter head for joining piece formation forms the joining piece of the sheet. When that is done, the first cutting blade cuts the sheet while rotating in the two intersecting directions, and the first cutting blade is able to cut and form the joining piece with a high degree of accuracy by evenly contacting, without partially contacting, the outer peripheral surface of the receiving side slotter head.

Further, a box making machine according to the present invention includes a feeder unit that feeds a sheet, a printing unit that executes printing on the sheet, a slotter creaser unit that has the slotter apparatus according to claim 10 that executes creasing and slotting on a surface of the sheet, a folding unit that forms a box body by folding the sheet and joining end portions thereof together, and a counter-ejector unit that ejects box bodies per a predetermined number of the box bodies after stacking the box bodies while counting the box bodies.

Therefore, printing is executed in the printing unit on the sheet from the feeder unit, creasing and slotting are executed in the slotter creaser unit, the box body is formed by folding and joining of the end portions in the folding unit, and the box bodies are stacked while being counted in the counter-ejector unit. When that is done: the slotter apparatus cuts off the end portion of the sheet, executes slotting of the sheet, and forms the joining piece of the sheet; and in the slotter head, the first cutting blade cuts the sheet while rotating in the two intersecting directions; and thus the first cutting blade is able to cut and form the joining piece with a high degree of accuracy by evenly contacting, without partially contacting, the outer peripheral surface of the receiving side slotter head.

### Advantageous Effects of Invention

According to a slotter head, a slotter apparatus, and a box making machine of the present invention, since a movable block, to which a first cutting blade is fixed, is made rotatable by a first support shaft around a first shaft center along a rotation shaft center direction of a cutter rest, and is made rotatable by a second support shaft around a second shaft center along a circumferential direction of the cutter rest; even if an inter-shaft distance between a pair of slotter heads is adjusted, the first cutting blade evenly contacts, without partially contacting, an outer peripheral surface of the receiving side slotter head, and a joining piece is able to be cut and formed with a high degree of accuracy.

### BRIEF DESCRIPTION OF DRAWINGS

FIG. 1 is a diagram of a schematic configuration illustrating a box making machine of a first embodiment.

FIG. 2 is a diagram of a schematic configuration illustrating a slotter apparatus of the first embodiment.

FIG. 3 is a perspective view illustrating the slotter apparatus.

FIG. 4 is a plan view illustrating a slotter head of the first embodiment.

FIG. 5 is a front view illustrating the slotter head.

FIG. 6 is a side view illustrating the slotter head.

FIG. 7 is a VII-VII cross sectional view of FIG. 4.

FIG. 8 is an exploded perspective view illustrating the slotter head.

FIG. 9 is a plan view illustrating a modified example of the slotter head of the first embodiment.

FIG. 10 is a perspective view of a corrugated board sheet before processing thereof.

FIG. 11 is a perspective view of the corrugated board sheet after creasing and slotting.

FIG. 12 is a perspective view of the corrugated board sheet illustrating a state in the middle of being folded.

FIG. 13 is a perspective view of the corrugated board box that has been folded and joined.

FIG. 14 is a plan view illustrating a slotter head of a second embodiment.

FIG. 15 is a front view illustrating the slotter head.

FIG. 16 is a side view illustrating the slotter head.

### DESCRIPTION OF EMBODIMENTS

Hereinafter, preferred embodiments of a slotter head, a slotter apparatus, and a box making machine, according to the present invention, will be described in detail, by reference to the appended drawings. The present invention is not limited by these embodiments, and when there are plural embodiments, the present invention includes those configured of any combination of the respective embodiments.

### First Embodiment

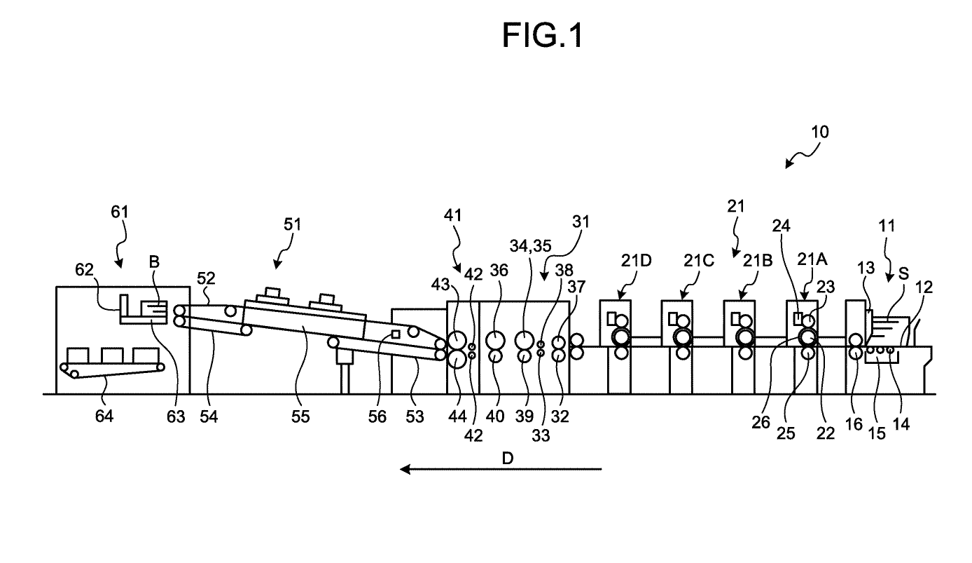

FIG. 1 is a diagram of a schematic configuration illustrating a box making machine of a first embodiment.

In the first embodiment, as illustrated in FIG. 1, a box making machine 10 makes a corrugated board box (box body) B by processing a corrugated board sheet S. This box making machine 10 is formed of: a feeder unit 11; a printing unit 21; a slotter creaser unit 31; a die cut unit 41; a folding unit 51; and a counter-ejector unit 61, which are linearly arranged in a direction D of conveying the corrugated board sheet S and the corrugated board box B.

The feeder unit 11 feeds corrugated board sheets S at a constant velocity to the printing unit 21 by sending out the corrugated board sheets S one by one. This feeder unit 11 has a table 12, a front stopper 13, feeding rollers 14, a suction device 15, and feed rolls 16. Many corrugated board sheets S are able to be stacked and placed on the table 12, and the table 12 is liftably and lowerably supported. The front stopper 13 is able to position front end positions of the corrugated board sheets S stacked on the table 12, and a gap, through which a single corrugated board sheet S is passable, is kept between a lower end portion of the front stopper 13 and the table 12. The feeding rollers 14 are plurally arranged, correspondingly to the table 12, in the conveyance direction D of the corrugated board sheet S, and are able to send out forward the corrugated board sheet S that is at the lowest position of the many stacked corrugated board sheets S when the table 12 is lowered. The suction device 15 sucks the stacked corrugated board sheets S downward, that is, toward the table 12 and the feeding rollers 14. The feed rolls 16 are able to feed the corrugated board sheet S sent out from the feeding rollers 14, to the printing unit 21.

The printing unit 21 executes multicolored printing (four-color printing in this embodiment) on a surface of the corrugated board sheet S. This printing unit 21 has four printing units 21A, 21B, 21C, and 21D that are serially arranged, and is able to execute printing by using four ink colors, on the surface of the corrugated board sheet S. The respective printing units 21A, 21B, 21C, and 21D are formed substantially in the same way, and each have a printing cylinder 22, an ink supply roll (anilox roll) 23, an ink chamber 24, and a receiving roll 25. The printing cylinder 22 has a printing die 26 on an outer peripheral portion thereof, and is rotatably provided. The ink supply roll 23 is arranged to face and contact the printing die 26 near the printing cylinder 22, and is rotatably provided. The ink chamber 24 stores therein ink, and is provided near the ink supply roll 23. The receiving roll 25 conveys the corrugated board sheet S while applying a predetermined printing pressure on the corrugated board sheet S by sandwiching the corrugated board sheet S between the receiving roll 25 and the printing cylinder 22, and is rotatably provided opposite to a lower portion of the printing cylinder 22. Although illustration thereof will be omitted, pairs of upper and lower feeding rolls are provided before and after each of the printing units 21A, 21B, 21C, and 21D.

The slotter creaser unit 31 has a slotter apparatus, and executes creasing and executes slotting, on the corrugated board sheet S. This slotter creaser unit 31 has first creasing rolls 32, second creasing rolls 33, a slitter head 34, first slotter heads 35, and second slotter heads 36.

The first creasing rolls 32 are circularly formed, are plurally arranged (four in this embodiment) at predetermined intervals in a horizontal direction orthogonal to the conveyance direction D of the corrugated board sheet S, and are rotatable by a driving device not illustrated. The second creasing rolls 33 are circularly formed, are plurally arranged (four in this embodiment) at predetermined intervals in a horizontal direction orthogonal to the conveyance direction D of the corrugated board sheet S, and are rotatable by a driving device not illustrated. In this case, the first creasing rolls 32 arranged at a lower side execute creasing on a reverse surface (lower surface) of the corrugated board sheet S, the second creasing rolls 33 arranged at the lower side execute, similarly to the first creasing rolls 32, creasing on the reverse surface (lower surface) of the corrugated board sheet S, and at upper positions opposite to the respective creasing rolls 32 and 33, receiving rolls 37 and 38 are rotatably provided to synchronize therewith.

The slitter head 34 and the first slotter heads 35 are circularly formed, are plurally arranged (five in this embodiment) at predetermined intervals in a horizontal direction orthogonal to the conveyance direction D of the corrugated board sheet S, and are rotatable by a driving device not illustrated. The slitter head 34 is singly formed, is provided correspondingly to a width direction end portion of the conveyed corrugated board sheet S, and is able to cut off this width direction end portion of the corrugated board sheet S. The first slotter heads 35 are formed of four slotter heads, are provided correspondingly to predetermined width direction positions of the conveyed corrugated board sheet S, and are able to execute slotting at these predetermined positions of the corrugated board sheet S, and to execute formation of a gluing margin piece. The second slotter heads 36 are formed of four slotter heads, are provided correspondingly to predetermined width direction positions of the conveyed corrugated board sheet S, and are able to execute slotting at these predetermined positions of the corrugated board sheet S, and to execute formation of the gluing margin piece. In this case, lower blades 39 are rotatably provided to synchronize therewith at positions opposite to and below the slitter head 34 and first slotter heads 35, and lower blades 40 are rotatably provided to synchronize therewith at positions opposite to and below the second slotter heads 36.

The die cut unit 41 executes punching for hand holes on the corrugated board sheet S. This die cut unit 41 has a pair of upper and lower feeding pieces 42, an anvil cylinder 43, and a head cylinder 44. The feeding pieces 42 convey the corrugated board sheet S while sandwiching the corrugated board sheet S from thereabove and therebelow, and are rotatably provided. The anvil cylinder 43 and head cylinder 44 are each circularly formed, and are rotatable to synchronize with each other by a driving device not illustrated. In this case, an anvil is formed in an outer peripheral portion of the anvil cylinder 43, and a head and a die are formed at predetermined positions of an outer peripheral portion of the head cylinder 44.

The folding unit 51 forms the corrugated board box B in a flat form, by folding the corrugated board sheet S while moving the corrugated board sheet S in the conveyance direction D and joining width direction end portions thereof together. This folding unit 51 has an upper conveyance belt 52, lower conveyance belts 53 and 54, and a forming device 55. The upper conveyance belt 52 and the lower conveyance belts 53 and 54 convey the corrugated board sheet S and the corrugated board box B by sandwiching them from thereabove and therebelow. The forming device 55 has a pair of left and right forming belts, and the corrugated board sheet S is folded while each of the width direction end portions of the corrugated board sheet S is bent, by these forming belts. Further, the folding unit 51 has a gluing device 56 provided therein. This gluing device 56 has a glue gun, and is able to execute gluing at a predetermined position on the corrugated board sheet S by discharging glue at a predetermined time.

The counter-ejector unit 61 ejects the corrugated board boxes B after sorting them into a predetermined number of batches, after stacking them while counting them. This counter-ejector unit 61 has a hopper device 62. This hopper device 62 has an elevator 63, on which the corrugated board boxes B are able to be stacked, and which is liftable and lowerable, and this elevator 63 has a front stopper and an angle adjusting plate provided therein, which serve as a shaping means and are not illustrated. An ejection conveyor 64 is provided below the hopper device 62.

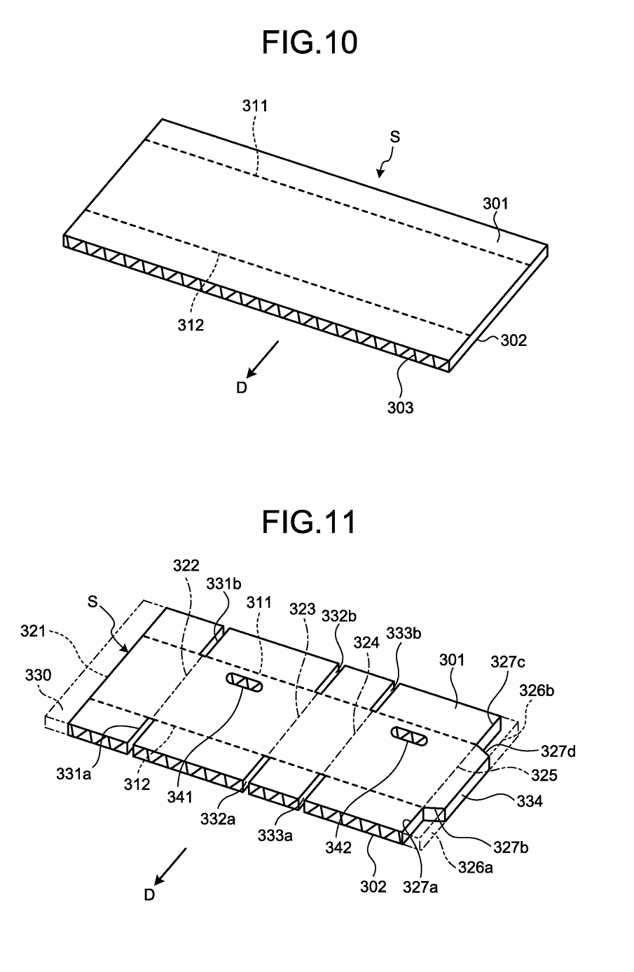

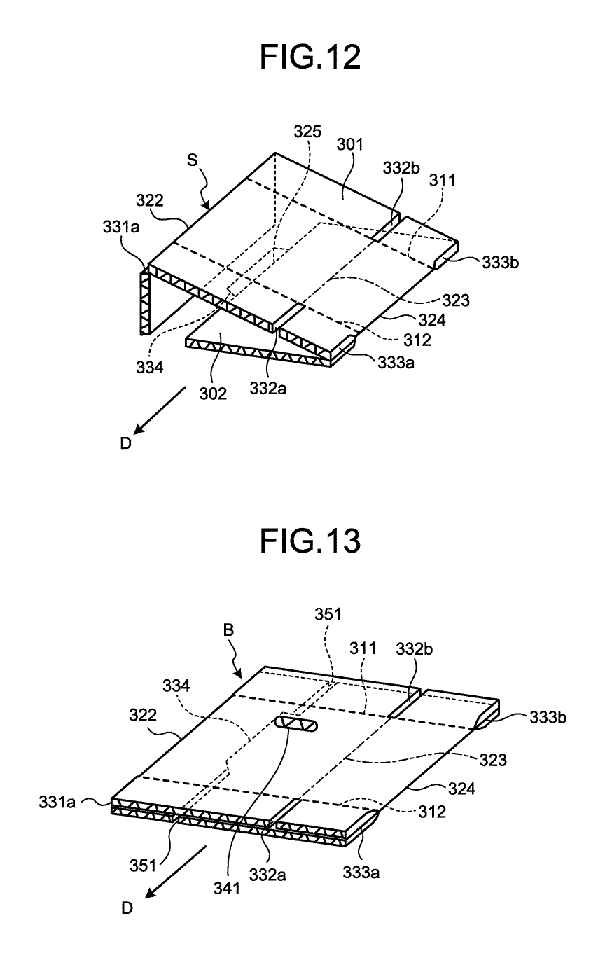

Operation of making the corrugated board box B from the corrugated board sheet S in the above described box making machine of the first embodiment will now be described. FIG. 10 is a perspective view of a corrugated board sheet before processing, FIG. 11 is a perspective view of the corrugated board sheet after creasing and slotting, FIG. 12 is a perspective view of the corrugated board sheet illustrating a state in the middle of being folded, and FIG. 13 is a perspective view of a corrugated board box that has been folded and joined.

As illustrated in FIG. 10, the corrugated board sheet S is formed by gluing of a corrugating medium 303 having a corrugated form, between a front liner 301 and a back liner 302. This corrugated board sheet S has two bend lines 311 and 312 that have been formed in a process upstream of the box making machine 10. These bend lines 311 and 312 are for folding of flaps when the corrugated board box B made by the box making machine 10 is set up later. These corrugated board sheets S are stacked on the table 12 of the feeder unit 11, as illustrated in FIG. 1.

In the feeder unit 11, the many corrugated board sheets S that have been stacked on the table 12 are firstly positioned by the front stopper 13, and subsequently, the table 12 is lowered, and thereby, the corrugated board sheet S at the lowest position is sent out by the plural feeding rollers 14. This corrugated board sheet S is then fed to the printing unit 21 at a predetermined certain velocity by the pair of feed rolls 16.

In the printing unit 21, at each of the printing units 21A, 21B, 21C, and 21D, the ink is supplied from the ink chamber 24 to a surface of the ink supply roll 23, and as the printing cylinder 22 and the ink supply roll 23 rotate, the ink on the surface of the ink supply roll 23 is transferred onto the printing die 26. When the corrugated board sheet S is conveyed to between the printing cylinder 22 and the receiving roll 25, this corrugated board sheet S is sandwiched between the printing die 26 and the receiving roll 25, and printing is executed on a surface of the corrugated board sheet S by printing pressure being applied on the corrugated board sheet S. The corrugated board sheet S that has been subjected to the printing is conveyed to the slotter creaser unit 31 by the feeding rolls.

In the slotter creaser unit 31, firstly, as the corrugated board sheet S passes the first creasing rolls 32, as illustrated in FIG. 11, on a reverse surface side, that is on the back liner 302 side, of the corrugated board sheet S, creasings 322, 323, 324, and 325 are formed. Further, as the corrugated board sheet S passes the second creasing rolls 33, similarly to the first creasing rolls 32, on the reverse surface side, that is, the back liner 302 side, of the corrugated board sheet S, the creasings 322, 323, 324, and 325 are formed again.

Subsequently, as the corrugated board sheet S, on which these creasings 322, 323, 324, and 325 have been formed, passes the slitter head 34, an end portion 330 is cut off at a position of a cut position 321. Further, as the corrugated board sheet S passes the first slotter heads 35, slots 331a, 332a, and 333a are formed at positions of the creasings 322, 323, and 324. Upon this formation, an end portion 326a is cut off at a position of the creasing 325. Furthermore, as the corrugated board sheet S passes the second slotter heads 36, slots 331b, 332b, and 333b are formed at the positions of the creasings 322, 323, and 324. Upon this formation, an end portion 326b is cut off at the position of the creasing 325, and a gluing margin piece (joining piece) 334 is formed. Thereafter, the corrugated board sheet S, in which the slots 331a, 332a, 333a, 331b, 332b, and 333b and the gluing margin piece 334 have been formed at the positions of the creasings 322, 323, 324, and 325, is conveyed to the die cut unit 41.

In the die cut unit 41, as illustrated in FIG. 1, as the corrugated board sheet S passes between the anvil cylinder 43 and the head cylinder 44, hand holes 341 and 342 are formed. The corrugated board sheet S, in which the hand holes 341 and 342 have been formed, is conveyed to the folding unit 51.

In the folding unit 51, while the corrugated board sheet S is moved in the conveyance direction D by the upper conveyance belt 52 and the lower conveyance belts 53 and 54, glue is applied onto the gluing margin piece 334 by the gluing device 56, and thereafter, the corrugated board sheet S is folded, by the forming device 55, downward with the creasings 322 and 324 being base points, as illustrated in FIG. 12. When this folding proceeds to near 180 degrees, folding force is increased, the gluing margin piece 334 and an end portion of the corrugated board sheet S overlapping this gluing margin piece 334 are pressed down and closely contacted with each other, both end portions of the corrugated board sheet S are joined together, and as illustrated in FIG. 13, the corrugated board box B is thereby formed. Upon the formation, two gaps 351 are formed in the joined part. This corrugated board box B is then, as illustrated in FIG. 1, conveyed to the counter-ejector unit 61.

In the counter-ejector unit 61, the corrugated board boxes B that have been detected as non-defective are sent to the hopper device 62. The corrugated board boxes B sent to the hopper device 62 are stacked on the elevator 63, in a state where their conveyance direction D front end portions contact the front stopper and are shaped by the angle adjusting plate. When a predetermined number of corrugated board boxes B have been stacked on the elevator 63, the elevator 63 is lowered, the predetermined number of corrugated board boxes B is ejected by the ejection conveyor 64 in a batch, and are fed to a process downstream from the box making machine 10.

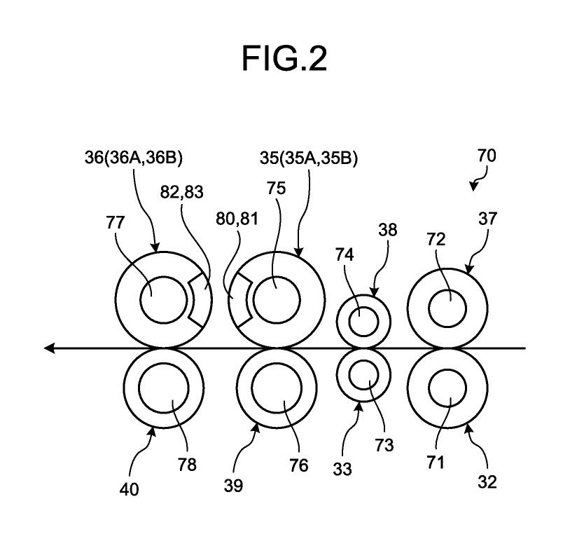

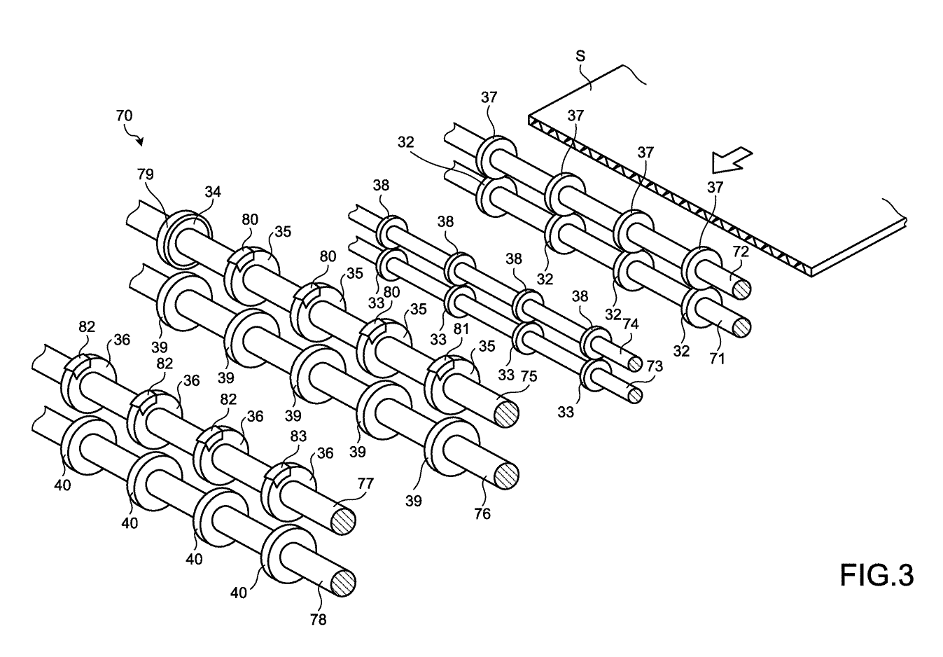

The slotter creaser unit 31 having the slotter apparatus of the first embodiment will now be described in detail. FIG. 2 is a diagram of a schematic configuration illustrating the slotter apparatus of the first embodiment, and FIG. 3 is a perspective view illustrating the slotter apparatus.

In the slotter creaser unit 31, a slotter apparatus 70 executes creasing and executes slotting, on the corrugated board sheet S, as illustrated in FIG. 2 and

FIG. 3. This slotter apparatus 70 is formed of: the first creasing rolls 32 and receiving rolls 37; the second creasing rolls 33 and receiving rolls 38; the slitter head (upper slitter head) 34, first slotter heads (upper slotter heads) 35, and lower blades (lower slitter head and lower slotter heads) 39; and the second slotter heads (upper slotter heads) 36 and lower blades (lower slotter heads) 40.

Each of end portions of upper and lower roll shafts 71 and 72 is rotatably supported by a frame not illustrated, the four first creasing rolls 32 are fixed to the lower roll shaft 71 at predetermined intervals in a shaft direction thereof, and the four receiving rolls 37 are fixed to the upper roll shaft 72 at predetermined intervals in a shaft direction thereof. Further, each of end portions of upper and lower roll shafts 73 and 74 is rotatably supported by a frame not illustrated, the four second creasing rolls 33 are fixed to the lower roll shaft 73 at predetermined intervals in a shaft direction thereof, and the four receiving rolls 38 are fixed to the upper roll shaft 74 at predetermined intervals in a shaft direction thereof.

In this case, the respective first creasing rolls 32 and the respective receiving rolls 37, as well as the respective second creasing rolls 33 and the respective receiving rolls 38, are arranged vertically opposite to each other. Further, the respective second creasing rolls 33 are arranged downstream from the respective first creasing rolls 32, with a predetermined gap therefrom in the horizontal direction. The first creasing rolls 32 and the second creasing rolls 33 are arranged at the same positions along the shaft directions of the roll shafts 71 and 73, and diameters of the second creasing rolls 33 are set smaller than diameters of the first creasing rolls 32.

Therefore, the first creasing rolls 32 and the receiving rolls 37 are arranged vertically opposite to each other; and when the corrugated board sheet S enters between these first creasing rolls 32 and receiving rolls 37, outer peripheral portions of the first creasing rolls 32 and outer peripheral portions of the receiving rolls 37 sandwich the corrugated board sheet S, and as this corrugated board sheet S passes between the first creasing rolls 32 and the receiving rolls 37, creasings are formed on a lower surface thereof. Further, the second creasing rolls 33 and the receiving rolls 38 are arranged vertically opposite to each other; and when the corrugated board sheet S enters between these second creasing rolls 33 and receiving rolls 38, outer peripheral portions of the second creasing rolls 33 and outer peripheral portions of the receiving rolls 38 sandwich the corrugated board sheet S, and as this corrugated board sheet S passes between the second creasing rolls 33 and the receiving rolls 38, creasings are formed on the lower surface. In this case, on the corrugated board sheet S, a single creasing is formed by the first creasing roll 32 and the second creasing roll 33 rolling over the same position.

Further, each of end portions of upper and lower slotter shafts (rotation shafts) 75 and 76 is rotatably supported by a frame not illustrated; and the single slitter head 34 and the four first slotter heads 35 (35A and 35B) are fixed to the upper slotter shaft 75 at predetermined intervals in a shaft direction thereof, and the five lower blades 39 are fixed to the lower slotter shaft 76 at predetermined intervals in a shaft direction thereof. In this case, one of the lower blades (lower blade for slitter head) 39 is arranged correspondingly to the single slitter head 34, and four of the lower blades (lower blades for slotter heads) 39 are arranged correspondingly to the four first slotter heads 35. Furthermore, each of end portions of upper and lower slotter shafts (rotation shafts) 77 and 78 is rotatably supported by a frame not illustrated; and the four second slotter heads 36 (36A and 36B) are fixed to the upper slotter shaft 77 at predetermined intervals in a shaft direction thereof, and the four lower blades 40 are fixed to the lower slotter shaft 78 at predetermined intervals in a shaft direction thereof.

Further, to an outer peripheral portion of the single slitter head 34, a slitter knife (cutting blade) 79 is fixed; to each of outer peripheral portions of the three first slotter heads 35A, a slotter knife (cutting blade) 80 is fixed; and to an outer peripheral portion of the single first slotter head 35B, a slotter knife (cutting blade) 81 is fixed. Furthermore, to each of outer peripheral portions of the three second slotter heads 36A, a slotter knife (cutting blade) 82 is fixed; and to an outer peripheral portion of the single second slotter head 36B, a slotter knife (cutting blade) 83 is fixed.

The slitter head 34 is used for cutting of end portions, and is able to cut off the end portion 330 at the cut position 321 in FIG. 11. On the whole circumference of this slitter head 34, the slitter knife 79 is provided. Moreover, the three first slotter heads 35A and the three second slotter heads 36A are used for slotting, and are able to form the slots 331a, 332a, 333a, 331b, 332b, and 333b in FIG. 11. The slotter knives 80 and 82 are partially provided in circumferential directions of the first slotter heads 35A and second slotter heads 36A. What is more, the single first slotter head 35B and the single second slotter head 36B are arranged at end portions of the slotter shafts 75 and 77, are used for formation of the gluing margin piece, and are able to form the gluing margin piece 334 by cutting off the end portions 326a and 326b in FIG. 11. The slotter knives 81 and 83 are partially provided in circumferential directions of the first slotter head 35B and second slotter head 36B.

In this case, the slitter head 34 and first slotter heads 35, and the lower blades 39 are respectively arranged vertically opposite to each other, and the second slotter heads 36 and the lower blades 40 are respectively arranged vertically opposite to each other. Further, the slitter head 34 and respective first slotter heads 35 are arranged downstream from the respective second creasing rolls 33 with a predetermined gap therefrom in the horizontal direction, and the respective second slotter heads 36 are arranged downstream from the respective first slotter heads 35 with a predetermined gap therefrom in the horizontal direction. The respective second creasing rolls 33, and the slitter head 34 and respective first slotter heads 35 are arranged at the same positions along the shaft directions of the slotter shafts 73 and 76, and the respective first slotter heads 35 and the respective second slotter heads 36 are arranged at the same positions along the shaft directions of the slotter shafts 75 and 77.

Therefore, as the corrugated board sheet S enters and passes between the slitter head 34 and first slotter heads 35A and 35B and the lower blades 39: the end portion of the corrugated board sheet S is cut off by the slitter knife 79 of the slitter head 34; slotting is executed by the slotter knives 80 of the first slotter heads 35A; and the gluing margin piece is formed by the slotter knife 81 of the first slotter head 35B. As the corrugated board sheet S passes between the first slotter heads 35A and 35B and the lower blades 39, the corrugated board sheet S is sandwiched and conveyed by the outer peripheral portions of the first slotter heads 35A and 35B and outer peripheral portions of the lower blades 39, in areas where the slotter knives 80 and 81 are not provided in the outer peripheral portions thereof. Further, as the corrugated board sheet S enters and passes between the second slotter heads 36A and 36B and the lower blades 40, the corrugated board sheet S is subjected to slotting by the slotter knives 82 of the second slotter heads 36A and the gluing margin piece is formed in the corrugated board sheet S by the slotter knife 83 of the first slotter head 36B. As the corrugated board sheet S passes between the second slotter heads 36A and 36B and the lower blades 40, the corrugated board sheet S is sandwiched and conveyed by the outer peripheral portions of the second slotter heads 36A and 36B and outer peripheral portions of the lower blades 40, in areas where the slotter knives 82 and 83 are not provided in the outer peripheral portions thereof.

Since the slotter heads 35A and 36A form the slots 331a, 332a, 333a, 331b, 332b, and 333b that are along the conveyance direction D of the corrugated board sheet S, the slotter knives 80 and 82 are fixed to the slotter heads 35A and 36A along the circumferential directions of the outer peripheral portions thereof. Since the slotter heads 35B and 36B cut the end portions 326a and 326b in a direction orthogonal to the conveyance direction D of the corrugated board sheet S to form the gluing margin piece 334, the slotter knives 81 and 83 are fixed to the slotter heads 35B and 36B along the circumferential directions of the outer peripheral portions thereof and along a rotation shaft center direction.

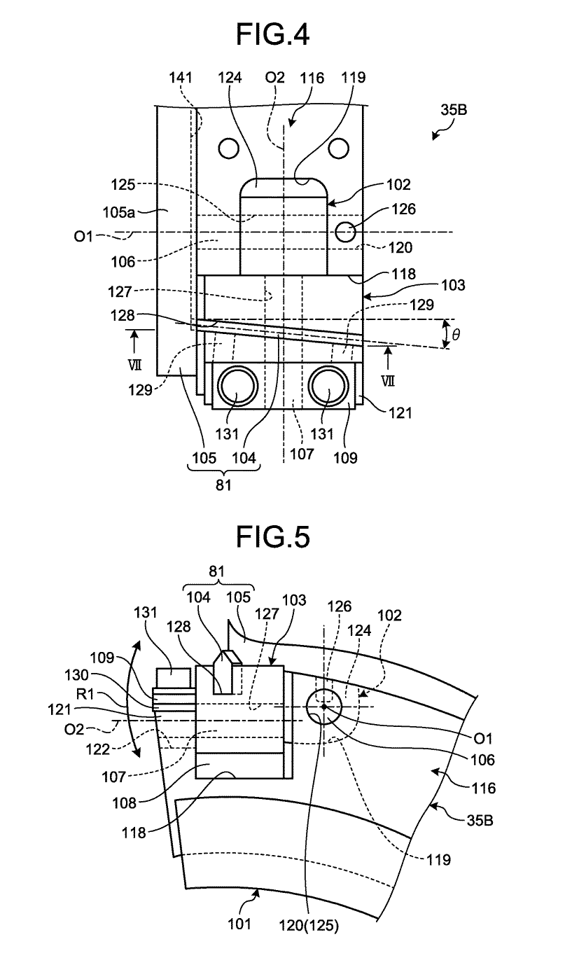

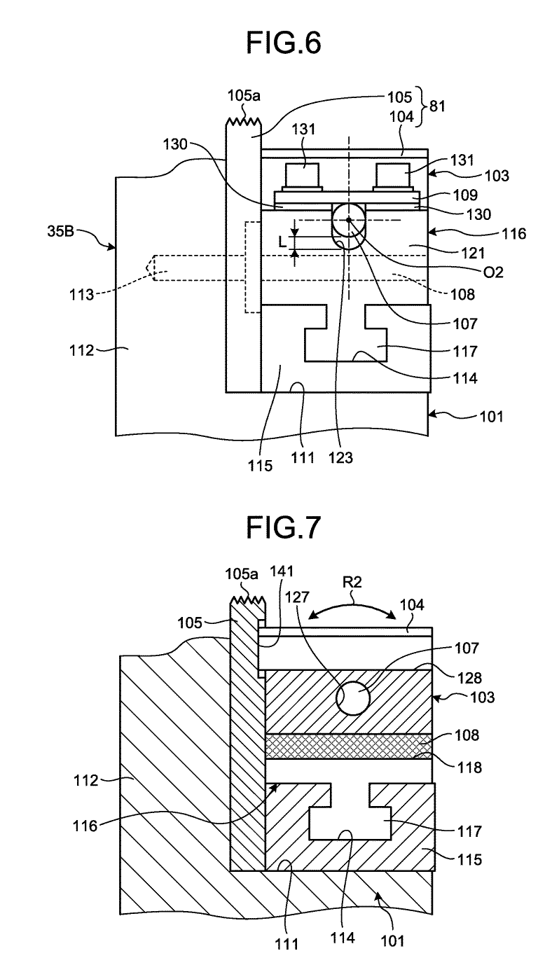

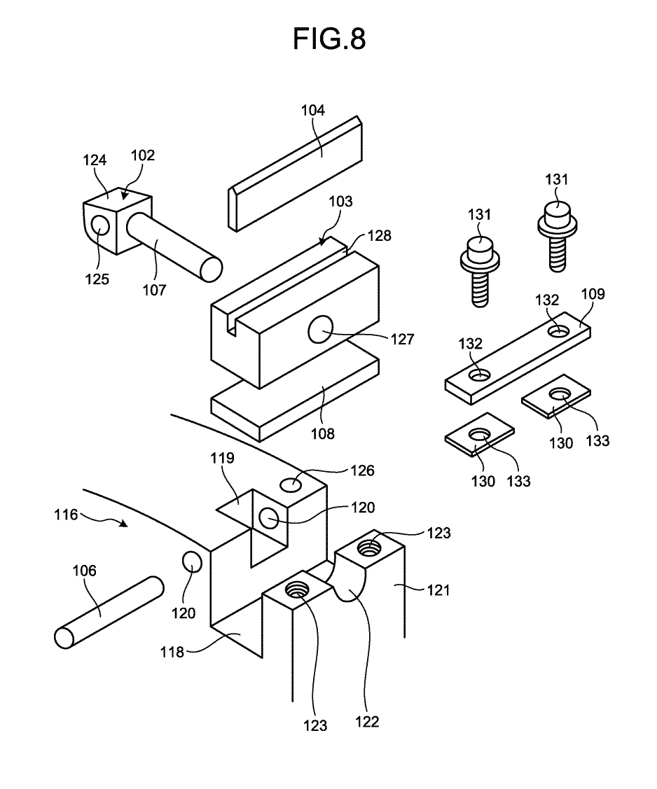

Hereinafter, detailed description will be made with respect to the slotter heads 35B and 36B, but since they have substantially the same configuration, the first slotter head 35B will be described. FIG. 4 is a plan view illustrating a slotter head of the first embodiment, FIG. 5 is a front view illustrating the slotter head, FIG. 6 is a side view illustrating the slotter head, FIG. 7 is a VII-VII cross sectional view of FIG. 4, and FIG. 8 is an exploded perspective view illustrating the slotter head. In the following description, when “circumferential direction” is simply referred to, this circumferential direction means the circumferential direction of the first slotter head 35B; when “shaft direction” is simply referred to, this shaft direction means the rotation shaft center direction of the first slotter head 35B; and when “radial direction” is simply referred to, this radial direction means a radial direction of the first slotter head 35B.

The first slotter head (hereinafter, slotter head) 35B has, as illustrated in FIG. 4 to FIG. 8: a cutter rest 101; a link member 102; a movable block 103; a first cutting blade 104 and a second cutting blade 105, which form the slotter knife 81; a first support shaft 106; a second support shaft 107; rubber (biasing member) 108; and a restricting plate (restricting member) 109.

The cutter rest 101 is disk shaped, and is fixed to and rotatably supported by the slotter shaft 75. The cutter rest 101 has an accommodating recessed portion 111 provided in an outer peripheral portion thereof, the accommodating recessed portion 111 being along the circumferential direction and opening to one side in the shaft direction. The second cutting blade 105 is fan shaped, and has a blade portion 105a formed in an outer peripheral portion thereof. This second cutting blade 105 is arranged to closely contact a vertical wall portion 112 in the accommodating recessed portion 111, and is fixed by plural bolts 113. In this case, the blade portion 105a of the second cutting blade 105 is positioned outer than an outer peripheral portion of the vertical wall portion 112.

A guide member 115 having a guide rail 114 along the circumferential direction is fixed to the accommodating recessed portion 111 of the cutter rest 101. One of side surface portions of the guide member 115 closely contacts a planar portion of the second cutting blade 105, and the other one of the side surface portions is substantially coplanar with a side surface portion of the cutter rest 101. A cutter mount 116 is fan shaped in a front view thereof (FIG. 5), and a guide portion 117 at a lower portion thereof is fitted into the guide rail 114 of the guide member 115. The cutter mount 116 is movable in the circumferential direction with respect to the guide member 115, but is fixed to a predetermined position by a bolt not illustrated.

The cutter mount 116 has a block attachment recessed portion 118 formed in an outer peripheral portion thereof, the block attachment recessed portion 118 opening outward and penetrating in the shaft direction, as well as a link attachment recessed portion 119 formed therein, which communicates into one side in the circumferential direction of the block attachment recessed portion 118. The cutter mount 116 has a support hole 120 formed therein, which penetrates through the link attachment recessed portion 119 in the shaft direction. This support hole 120 is a circular hole. Further, the cutter mount 116 has a support wall 121 provided to stand therein, at the other side in the circumferential direction of the block attachment recessed portion 118, and a notch guide 122 is formed at a shaft direction intermediate position in an upper end portion of this support wall 121. The notch guide 122 is a notch, which penetrates through the upper end portion of the support wall 121 in the circumferential direction, is substantially semicircular, and is long in the radial direction. Furthermore, the support wall 121 has screw holes 123 formed along the radial direction, in the upper end surface thereof, the screw holes 123 being positioned at both sides of the notch guide 122.

The link member 102 has an attachment portion 124 having a cuboidal block shape, and a proximal end portion of the second support shaft 107 that is linear is fixed to one surface of this attachment portion 124. Further, the link member 102 has a support hole 125 formed in the attachment portion 124, the support hole 125 being along the shaft direction orthogonal to the second support shaft 107. In a state where the attachment portion 124 has been fitted into the link attachment recessed portion 119 of the cutter mount 116 and the respective support holes 120 and 125 are in line with each other; the first support shaft 106 is fitted into the link member 102 and the first support shaft 106 is retained and fixed by a fixing bolt 126. Therefore, the link member 102 is rotatably supported by the first support shaft 106 on the cutter mount 116.

The movable block 103 has a cuboidal block shape, has a size that fits into the block attachment recessed portion 118 of the cutter mount 116, and both end surfaces thereof are substantially coplanar with flat surfaces of the cutter mount 116. The movable block 103 has a support hole 127 formed therein, which is linear along the circumferential direction, and the second support shaft 107 that has been fixed to the link member 102 is able to be fitted therein. The rubber 108 is made of a rubber material, has elastic force (biasing force), and biases the movable block 103 outward with respect to the cutter mount 116.

Therefore, the second support shaft 107 of the link member 102 is fitted into the support hole 127, and the movable block 103 is mounted in the block attachment recessed portion 118 of the cutter mount 116 via the rubber 108. Upon the mounting, the rubber 108 is fixed to the cutter mount 116 by a pin not illustrated. Therefore, the movable block 103 is rotatably supported by the second support shaft 107 on the link member 102. The movable block 103 is restrained unmovably in the second support shaft 107 direction with respect to the link member 102 by a restraint member not illustrated.

Further, the movable block 103 has a cutting blade attachment groove 128 on an upper surface portion thereof. The first cutting blade 104 is mounted in the cutting blade attachment groove 128, and is fixed by a fixing bolt 129. The first cutting blade 104 is fixed to the movable block 103 along a shaft center direction and along a direction inclined in the circumferential direction by a predetermined angle. That is, the first cutting blade 104 is inclined by a predetermined angle θ with respect to the shaft center direction.

In the link member 102, the second support shaft 107 is fitted into the support hole 127 of the movable block 103, and a distal end portion of the second support shaft 107 protrudes therefrom and is fitted into the notch guide 122 of the support wall 121 in the block attachment recessed portion 118. The restricting plate 109 restricts the amount of outward rotation of the movable block 103 by the first support shaft 106 with respect to the cutter mount 116. The restricting plate 109 closely contacts an upper surface of the support wall 121 via rubber (elastic members) 130 such that the restricting plate 109 presses down the second support shaft 107 in a state where the second support shaft 107 has been fitted into the notch guide 122. Fastening bolts 131 penetrate through holes 132 of the restricting plate 109 and through holes 133 of the rubber 130, and are screwed into the screw holes 123 of the support wall 121. Therefore, by the distal end portion of the second support shaft 107 being restricted by the restricting plate 109, the amount of outward rotation of the movable block 103 by the first support shaft 106 is restricted to a stroke L by the notch guide 122.

As a result, the movable block 103, to which the first cutting blade 104 has been fixed: is elastically supported by the rubber 108; is supported, with respect to the cutter rest 101 by the first support shaft 106, rotatably around a first shaft center O1 along the rotation shaft center direction of the cutter rest 101; and is supported by the second support shaft 107 rotatably around a second shaft center O2 along the circumferential direction of the cutter rest 101.

Further, the second cutting blade 105 has a recessed portion 141 provided on one of planar portions thereof, and one of end portions of the first cutting blade 104 is arranged in this recessed portion 141. A radial direction length of the recessed portion 141 is set to be a dimension larger than a height of the first cutting blade 104. Furthermore, the cutter mount 116, on which the first cutting blade 104 is supported, is positionally adjustable along the circumferential direction of the cutter rest 101, and thus a circumferential direction length of the recessed portion 141 is set to a dimension larger than the amount of movement of the first cutting blade 104.

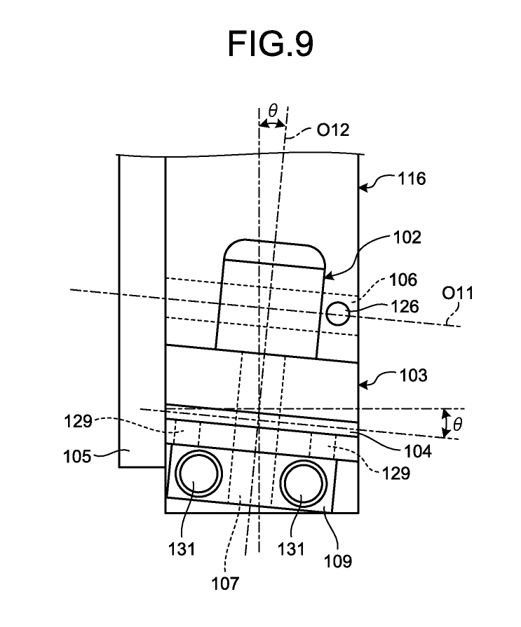

In the above described embodiment, the first cutting blade 104 is fixed to the movable block 103 while being inclined with respect to the shaft center direction by the predetermined angle θ, and this movable block 103 is supported rotatably around the first shaft center O1 along the rotation shaft center direction of the cutter rest 101 and is supported, by the second support shaft 107, rotatably around the second shaft center O2 along the circumferential direction of the cutter rest 101; but the embodiment is not limited to this configuration. FIG. 9 is a plan view illustrating a modified example of the slotter head of the first embodiment.

As illustrated in FIG. 9, the first cutting blade 104 is fixed to the movable block 103 by being inclined with respect to the shaft center direction by the predetermined angle θ, and this movable block 103 is supported rotatably around a first shaft center O11 along the rotation shaft center direction of the cutter rest 101 and is supported, by the second support shaft 107, rotatably around a second shaft center O12 along the circumferential direction of the cutter rest 101. The first shaft center O11 is positioned in a direction parallel to the first cutting blade 104, and the second shaft center O12 is positioned in a direction orthogonal to the first cutting blade 104.

The slotter head 35B configured as described above cuts off, as illustrated in FIG. 2 and FIG. 11, the end portion 326a, with the first cutting blade 104 and second cutting blade 105, which form the slotter knife 81, as the corrugated board sheet S passes between the slotter head 35B and the lower blade 39. That is, as the slotter knife 81 of the first slotter head 35B is pressed against the outer peripheral surface of the lower blade 39 via the corrugated board sheet S, the end portion 326a is cut off, by the second cutting blade 105 (see FIG. 5) cutting a cutting line 327a along the conveyance direction D and the first cutting blade 104 cutting a cutting line 327b along a direction intersecting the conveyance direction D. Further, as the slotter knife 83 of the second slotter head 36B is pressed against the outer peripheral surface of the lower blade 40 via the corrugated board sheet S, the end portion 326b is cut off, by the second cutting blade 105 cutting a cutting line 327c along the conveyance direction D and the first cutting blade 104 cutting a cutting line 327d along a direction intersecting the conveyance direction D. As a result, the gluing margin piece 334 is formed at the end portion of the corrugated board sheet S.

Upon the formation, as illustrated in FIG. 5 and FIG. 7, since the first cutting blade 104 is fixed to the movable block 103 by being inclined with respect to the shaft center direction by the predetermined angle θ, when the slotter head 35B and the lower blade 39 rotate, the cutting line 327b is cut by a blade edge gradually contacting the outer peripheral surface of the lower blade 39. That is, the first cutting blade 104 rotates along a rotating direction R2 around the second support shaft 107 (second shaft center O2) while rotating along a rotating direction R1 around the first support shaft 106 (first shaft center O1). This rotation of the first cutting blade 104 is enabled by the elastic support via the rubber 108, and the first cutting blade 104 is returned to the original position after the cutting. Therefore, the first cutting blade 104 is able to cut the cutting line 327b appropriately without partially contacting the outer peripheral surface of the lower blade 39.

As described above, provided in the slotter head of the first embodiment are: the cutter rest 101; the movable block 103 that is mounted in the outer peripheral portion of the cutter rest 101; the first cutting blade 104 that is fixed, to the movable block 103, along the shaft direction and along the direction inclined in the circumferential direction by the predetermined angle θ; the first support shaft 106 that supports, on the cutter rest 101, the movable block 103 rotatably around the first shaft center O1 along the shaft direction; and the second support shaft 107 that supports, on the cutter rest 101, the movable block 103 rotatably around the second shaft center O2 along the circumferential direction.

Therefore, as the corrugated board sheet S is conveyed between the first cutting blade 104 and the outer peripheral surface of the lower blade 39 opposite thereto, the first cutting blade 104 cuts the corrugated board sheet S while rotating in the two intersecting directions, and thus, the first cutting blade 104 evenly contacts, without partially contacting, the outer peripheral surface of the lower blade 39, and the gluing margin piece 334 is able to be cut and formed with a high degree of accuracy. Further, even if an inter-shaft distance between the slotter shafts 75 and 76 is adjusted according to the type of the corrugated board sheet S, since the first cutting blade 104 is rotatable in the two intersecting directions, the first cutting blade 104 is able to be evenly contacted with the outer peripheral surface of the lower blade 39.

Provided in the slotter head of the first embodiment are: the rubber 108 that biases the movable block 103 outward with respect to the cutter rest 101; and the restricting plate 109 that restricts the amount of outward rotation of the movable block 103 by the first support shaft 106 with respect to the cutter rest 101. Therefore, since the first cutting blade 104 is supported at a predetermined protruded position by the restricting plate 109, when the first cutting blade 104 cuts the corrugated board sheet S, the first cutting blade 104 rotates in the two intersecting directions while retracting against the biasing force of the rubber 108 correspondingly to the outer peripheral surface of the lower blade 39, and thus the gluing margin piece 334 is able to be cut with a high degree of accuracy. Further, impact upon the first cutting blade 104 cutting the corrugated board sheet S is able to be mitigated by the rubber 108.

In the slotter head of the first embodiment, the link member 102 having the second support shaft 107 is rotatably supported on the cutter rest 101 by the first support shaft 106, and the movable block 103 is rotatably supported on the link member 102 by the second support shaft 107. Therefore, the first support shaft 106, the second support shaft 107, and the first cutting blade 104 are able to be arranged closely to each other, and the whole configuration is able to be made compact. Further, the first support shaft 106 is tightly fitted into the support hole 120 of the cutter mount 116 and the support hole 125 of the link member 102, and the second support shaft 107 is tightly fitted into the support hole 127 of the movable block 103; and thus the movable block 103 rotates with a high degree of accuracy in only the two intersecting directions without shaking or rattling, and the first cutting blade 104 is able to be prevented from obliquely contacting the outer peripheral surface of the lower blade 39.

In the slotter head of the first embodiment, the rubber 108 is arranged between the cutter rest 101 and the movable block 103, the second support shaft 107 is fitted into the support hole 127 of the movable block 103 and the distal end portion of the second support shaft 107 protrudes therefrom, and the outward movement is restricted by the restricting plate 109. Therefore, with a simple configuration, the amount of rotation of the movable block 103 is able to be restricted easily.

In the slotter head of the first embodiment, the distal end portion of the second support shaft 107 is movably supported on the notch guide 122 along the radial direction in the outer peripheral portion of the cutter mount 116. Therefore, movement of the movable block 103 in the shaft direction of the first support shaft 106 is restricted, and the movable block 103 is able to be rotated with a high degree of accuracy.

In the slotter head of the first embodiment, the first shaft center O11 is positioned in a direction parallel to the first cutting blade 104, and the second shaft center O12 is positioned in a direction orthogonal to the first cutting blade 104. Therefore, the first cutting blade 104 rotates in its longitudinal direction and a direction orthogonal to the longitudinal direction, and thus is able to cut the corrugated board sheet S with a high degree of accuracy.

In the slotter head of the first embodiment, the second cutting blade 105 along the circumferential direction is fixed to the cutter rest 101, and the recessed portion 141 is provided on one of the planar portions of the second cutting blade 105, and one of the end portions of the first cutting blade 104 is arranged in this recessed portion 141. Therefore, a corner portion of the gluing margin piece 334 is able to be cut with a high degree of accuracy.

In the slotter head of the first embodiment, the rubber (elastic member) 130 is provided between the restricting plate 109 and the support wall 121. Therefore, height of the first cutting blade 104 is able to be adjusted via the second support shaft 107, that is, the movable block 103, by a vertical position of the restricting plate 109 being changed according to fastening torque of the fastening bolts 131.

Further, in the slotter apparatus of the first embodiment: the slitter head 34 that cuts off the end portion of the corrugated board sheet S, the slotter heads 35A that execute slotting, and the slotter head 35B that forms the joining piece, are provided on the upper slotter shaft 75; the slotter heads 36A that execute slotting on the corrugated board sheet S and the slotter head 36B that forms the joining piece, are provided on the upper slotter shaft 77; and the first cutting blades 104 that rotate in the two intersecting directions are provided in the slotter heads 35B and 36B for joining piece formation.

Therefore, the first cutting blade 104 is able to cut and form the gluing margin piece 334 with a high degree of accuracy by evenly contacting, without partially contacting, the outer peripheral surface of the lower blade 39, and thus quality of the corrugated board sheet S is able to be improved.

Further, in the box making machine of the first embodiment, the feeder unit 11, the printing unit 21, the slotter creaser unit 31, the die cut unit 41, the folding unit 51, and the counter-ejector unit 61 are provided, and the slotter apparatus 70 is provided in the slotter creaser unit 31.

Therefore, the first cutting blade 104 is able to cut and form the gluing margin piece 334 with a high degree of accuracy by evenly contacting, without partially contacting, the outer peripheral surface of the lower blade 39, and thus quality of the corrugated board sheet S is able to be improved.

### Second Embodiment

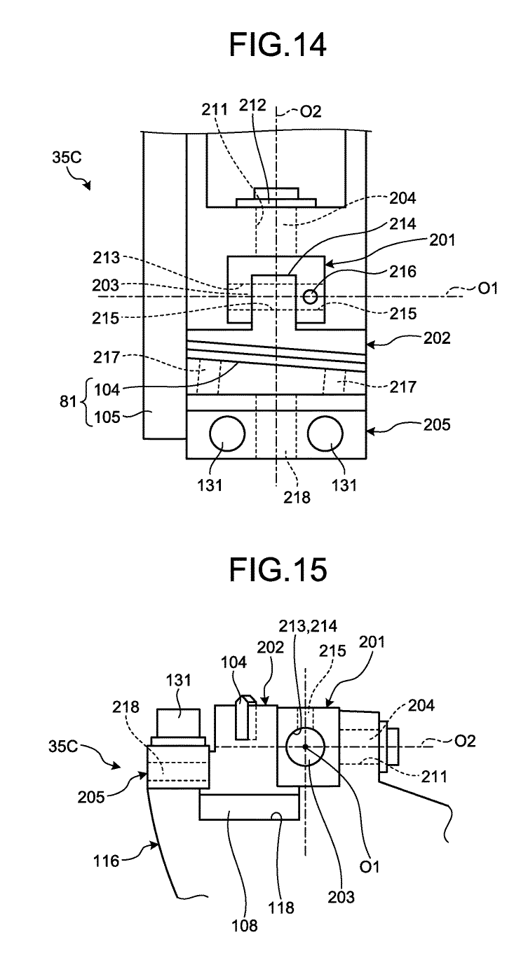

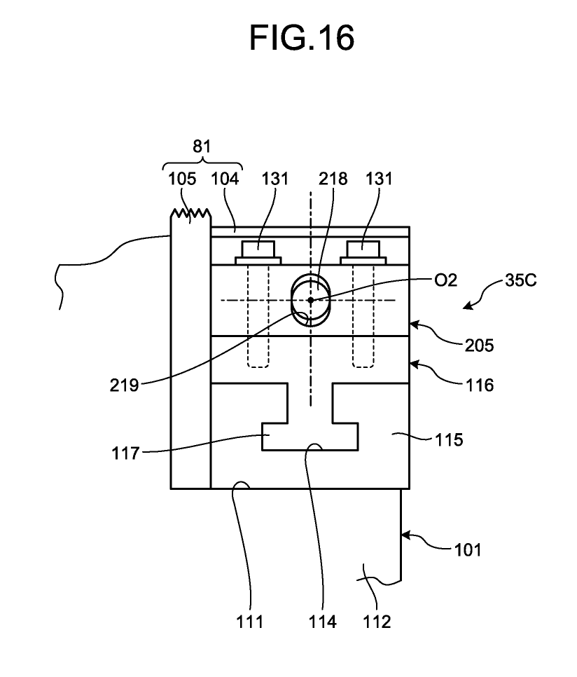

FIG. 14 is a plan view illustrating a slotter head of a second embodiment, FIG. 15 is a front view illustrating the slotter head, and FIG. 16 is a side view illustrating the slotter head. The same signs will be appended to parts having functions that are the same as those of the above described embodiment, and detailed description thereof will be omitted.

In the second embodiment, as illustrated in FIG. 14 to FIG. 16, a first slotter head (hereinafter, slotter head) 35C has the cutter rest 101, a link member 201, a movable block 202, the first cutting blade 104 and second cutting blade 105 forming the slotter knife 81, a first support shaft 203, a second support shaft 204, the rubber 108, and a restricting block (restricting member) 205.

The cutter mount 116 has the block attachment recessed portion 118 formed in an outer peripheral portion thereof, the block attachment recessed portion 118 opening outward and penetrating in the shaft direction, as well as a support hole 211 formed therein, which penetrates in the circumferential direction. The link member 201 has the second support shaft 204 that is linear and fixed to a proximal end portion thereof, and the second support shaft 204 is fitted into the support hole 211, and is retained and supported by a stop member 212. Further, the link member 201 has a support hole 213 formed in a distal end portion thereof, the support hole 213 penetrating therethrough in the shaft direction. The movable block 202 has a cuboidal block shape, and has a size that fits into the block attachment recessed portion 118 of the cutter mount 116, and a support hole 215 is formed in a proximal end portion 214 thereof, the support hole 215 penetrating therethrough in the shaft direction. The first support shaft 203 is fitted in the link member 201 and the movable block 202, in a state where their respective support holes 213 and 215 are in line with each other, and the first support shaft 203 is retained and fixed by a fixing bolt 216.

The rubber 108 is arranged between the block attachment recessed portion 118 of the cutter mount 116 and the movable block 202, and biases the movable block 202 outward with respect to the cutter mount 116. The first cutting blade 104 is mounted in an upper surface portion of the movable block 202, and is fixed by fixing bolts 217. The first cutting blade 104 is fixed to the movable block 202 along the shaft center direction and along a direction inclined in the circumferential direction by a predetermined angle.

A third support shaft 218 that protrudes in the circumferential direction is fixed to a distal end portion of the movable block 202. An elongated hole guide 219 is formed in the restricting block 205. The elongated hole guide 219 has an elongated hole shape penetrating through the restricting block 205 in the circumferential direction, and is elongated along the radial direction. The third support shaft 218 of the movable block 202 is fitted into the elongated hole guide 219 of the restricting block 205.

The restricting block 205 regulates the amount of outward rotation of the movable block 202 by the first support shaft 203, with respect to the cutter mount 116. In a state where the third support shaft 218 has been fitted into the elongated hole guide 219, the restricting block 205 is fixed to the cutter mount 116 by the fastening bolts 131 so as to press down the third support shaft 218. Therefore, by the distal end portion of the third support shaft 218 being restricted by the restricting block 205, the amount of outward rotation of the movable block 202 by the first support shaft 203 is restricted by the elongated hole guide 219.

As a result, the movable block 202, to which the first cutting blade 104 has been fixed: is elastically supported by the rubber 108; is supported, with respect to the cutter rest 101 by the first support shaft 203, rotatably around the first shaft center O1 along the rotation shaft center direction of the cutter rest 101; and is supported by the second support shaft 204 rotatably around the second shaft center O2 along the circumferential direction of the cutter rest 101.

Since the cutting processing of the corrugated board sheet S by the slotter head 35C of the second embodiment is substantially the same as that of the first embodiment, description thereof will be omitted.

As described above, provided in the slotter head of the second embodiment are: the cutter rest 101; the movable block 202 that is mounted in the outer peripheral portion of the cutter rest 101; the first cutting blade 104 that is fixed, to the movable block 202, along the shaft direction and along the direction inclined in the circumferential direction by the predetermined angle 0; the first support shaft 203 that supports, on the cutter rest 101, the movable block 202 rotatably around the first shaft center O1 along the shaft direction; and the second support shaft 204 that supports, on the cutter rest 101, the movable block 202 rotatably around the second shaft center O2 along the circumferential direction.

Therefore, as the corrugated board sheet S is conveyed between the first cutting blade 104 and the outer peripheral surface of the lower blade 39 opposite thereto, the first cutting blade 104 cuts the corrugated board sheet S while rotating in the two intersecting directions, and thus, the first cutting blade 104 evenly contacts, without partially contacting, the outer peripheral surface of the lower blade 39, and the gluing margin piece 334 is able to be cut and formed with a high degree of accuracy. Further, even if the inter-shaft distance between the slotter shafts 75 and 76 is adjusted according to the type of the corrugated board sheet S, since the first cutting blade 104 is rotatable in the two intersecting directions, the first cutting blade 104 is able to be evenly contacted with the outer peripheral surface of the lower blade 39.

In the slotter head of the second embodiment, the link member 201 is rotatably supported by the second support shaft 204 on the cutter rest 101, and the movable block 202 is rotatably supported by the first support shaft 203 on the link member 201. Therefore, the configuration is able to be simplified.

In the slotter head of the second embodiment, the rubber 108 is arranged between the cutter mount 116 and the movable block 202, the third support shaft 218 protruding in the circumferential direction of the cutter mount 116 is fixed to the movable block 202, and the third support shaft 218 is movably fitted into and supported by the elongated hole guide 219 provided along the radial direction in the restricting block 205; and thereby the outward movement of the movable block 202 is restricted. Therefore, with the simple configuration, the amount of rotation of the movable block 202 is able to be restricted easily, and the movement of the movable block 202 in the shaft center direction of the first support shaft 203 is restricted; and thus the movable block 202 is able to be rotated with a high degree of accuracy.

In the above described embodiments, the rubber 108 is used as the biasing member, but the embodiments are not limited to this configuration. For example, the shape of the rubber 108 may be modified, or as the biasing member, for example, a metal made or synthetic-resin made plate spring or coil spring may be used.

Further, in the above described embodiments, the box making machine is formed of the feeder unit 11, the printing unit 21, the slotter creaser unit 31, the die cut unit 41, the folding unit 51, and the counter-ejector unit 61, but if the hand holes 341 and 342 are not required in the corrugated board sheet S, the box making machine may be formed without the die cut unit 41.

1. A slotter head, comprising:
a cutter rest that is disk shaped, and is rotatably supported;
a movable block that is mounted in an outer peripheral portion of the cutter rest;
a first cutting blade that is fixed to the movable block along a rotation shaft center direction of the cutter rest and along a direction inclined in a circumferential direction by a predetermined angle;
a first support shaft that supports, on the cutter rest, the movable block rotatably around a first shaft center along the rotation shaft center direction of the cutter rest; and
a second support shaft that supports, on the cutter rest, the movable block rotatably around a second shaft center along a circumferential direction of the cutter rest.

2. The slotter head according to claim 1, wherein a biasing member that biases the movable block outward with respect to the cutter rest, and a restricting member that restricts an amount of outward rotation of the movable block by the first support shaft with respect to the cutter rest, are provided.

3. The slotter head according to claim 2, wherein a link member having the second support shaft is rotatably supported on the cutter rest by the first support shaft, and the movable block is rotatably supported on the link member by the second support shaft.

4. The slotter head according to claim 3, wherein the biasing member is arranged between the cutter rest and the movable block, the second support shaft is fitted into a support hole of the movable block and a distal end portion of the second support shaft protrudes therefrom, and outward movement thereof is restricted by the restricting member.

5. The slotter head according to claim 4, wherein the distal end portion of the second support shaft is movably supported on a notch guide that is provided, in the outer peripheral portion of the cutter rest, and along a radial direction of the cutter rest.

6. The slotter head according to claim 2, wherein a link member is rotatably supported on the cutter rest by the second support shaft, and the movable block is rotatably supported on the link member by the first support shaft.

7. The slotter head according to claim 6, wherein outward movement of the movable block is restricted by: the biasing member being arranged between the cutter rest and the movable block; a third support shaft being fixed to the movable block, the third support shaft protruding in the circumferential direction of the cutter rest; and the third support shaft being movably fitted into and supported by an elongated hole guide provided, in the restricting member, along a radial direction of the cutter rest.

8. The slotter head according to claim 1, wherein the first shaft center is positioned in a direction parallel to the first cutting blade, and the second shaft center is positioned in a direction orthogonal to the first cutting blade.

9. The slotter head according to claim 1, wherein: a second cutting blade along the circumferential direction of the cutter rest is fixed to the cutter rest, adjacently to the movable block in the rotation shaft center direction of the cutter rest; a recessed portion is provided in one of planar portions of the second cutting blade; and one of end portions of the first cutting blade is arranged in the recessed portion.

10. A slotter apparatus, comprising:
an upper rotation shaft and a lower rotation shaft that are rotatably supported;
an upper slitter head and a lower slitter head that are respectively fixed to the upper rotation shaft and the lower rotation shaft, and cut off an end portion of a sheet;
an upper slotter head and a lower slotter head for slotting that are respectively fixed to the upper rotation shaft and the lower rotation shaft, and execute slotting of the sheet; and
an upper slotter head and a lower slotter head for joining piece formation that are respectively fixed to the upper rotation shaft and the lower rotation shaft, and form a joining piece of the sheet; wherein
the slotter head according to claim 1 is used as the upper slotter head for joining piece formation.

11. A box making machine, comprising:
a feeder unit that feeds a sheet;
a printing unit that executes printing on the sheet;
a slotter creaser unit that has the slotter apparatus according to claim 10 that executes creasing and slotting on a surface of the sheet;
a folding unit that forms a box body by folding the sheet and joining end portions thereof together; and
a counter-ejector unit that ejects box bodies per a predetermined number of the box bodies after stacking the box bodies while counting the box bodies.
